(19) United States
(12) Patent Application Publication
(10) Pub. No.: US 2007/0178961 A1
(43) Pub. Date: Aug. 2, 2007

(54) Drum device and slot machine using the same and operation method thereof

(75) Inventor: Eiji Aida, Zama-shi (JP)

Correspondence Address: HARRITY SNYDER, LLP, 11350 Random Hills Road, SUITE 600, FAIRFAX, VA, 22030, US

(73) Assignee: Konami Gaming, Incorporated, Las Vegas, NV (US)

(21) Appl. No.: 11/654,026

(22) Filed: Jan. 17, 2007

(30) Foreign Application Priority Data
Jan. 24, 2006 (JP) 2006-015718

(51) Int. Cl. A63F 13/00

(52) U.S. Cl. 463/20

(57) ABSTRACT

A slot machine of the present invention having plural drum devices, each drum device comprises plural drums which have a cylindrical shape rotatable around the center axis and an array of plural symbols on its peripheral surface respectively, plural gyro sensors arranged in close vicinity to the center axis of each drum for detecting a rotating state of the center axis, and plural driving units for driving each drum. The drum device and slot machine using the drum device which detects the symbol positions of the drums in real time according to a rotating status of the center axis of the drums detected by the gyro sensor, and which do not require detection of an original position of starting of the drums, are provided.

### CROSS-REFERENCE TO RELATED APPLICATIONS

This application is based on and claims the benefit of priority from the prior Japanese Patent Application No. 2006-015718, filed on Jan. 24, 2006, the entire contents of which are incorporated herein by reference.

### TECHNICAL FIELD

The invention relates to a mechanical drum device for performing a moving and stationary display of symbols and the like and a slot machine using the same.

### BACKGROUND OF THE INVENTION

So-called slot machines are well known in placed such as casinos and game centers. The slot machine rotates drums on which are arranged symbols along the peripheral surfaces of the slot machine thereof. The slot machine is a gaming machine for determining a winning award or a non-winning award by combinations of symbols to be displayed on the drums when the drums are stopped after a determined passage of time or by a player's operation. Although machines with mechanical mechanisms were once dominant, in recent years there are many gaming machines which display video images on a display monitor.

In the slot machines installed in pachinko halls in Japan, so-called pinball-style slot machines control the rotation and stopping of the drums and the predetermined symbols displayed on the drums are forcibly rotated and transferred to a winning line position in a display window on every drum. Similarly, the predetermined symbols are also shifted to a non-winning line. Usually, aspects of awards such as a “big bonus”, a “medium bonus” and a “small bonus” are predetermined according to an array of symbols to be displayed in a state of stationary display. But there is a case that the symbols corresponding with the outcome of an internal lottery are not displayed on the winning line when the player clicks a stop button although the array of symbols to be displayed should be a win in the internal lottery. In this case, if the symbols are within an area which is from the winning line to a certain definite position above the winning line, the control which is referred to as “winning over” takes place. Therefore, the rotations of the drums are stopped after the symbols corresponding to the aspects of the award are shifted to the winning line by the “winning over”. However, even if the array of symbols to be displayed is a win in the internal lottery, the “winning over” is not performed when the symbols corresponding to the aspect of award are not within the area to the certain definite position in a click of the stop button. On the other hand, though the array of symbols is not a win in the internal lottery, when the symbols satisfying the aspect of awards are on the winning line or in this vicinity in a click of the stop button, and the symbols are likely to stop and to be displayed on the winning line, the rotation control of the drums, a so-called “skipping” which shifts the symbols straight from the winning line, is performed. Such a control stated above is generally called a stop control in a pinball-style slot machine.

When the “small bonus” is won, the predetermined number of coins is paid out as an award depending on the kind of “small bonus”. Alternatively, a “replay” is granted which enables the player to replay the game with the same number of bets.

When the “medium bonus” or the “big bonus” are won, special games may be granted which awards the aspects of the “small bonus” and the “medium bonus” in the internal lottery at a high probability and only in a determined time.

Of course within Japan, the control performances of the pinball-style slot machine described above are carried out with legal control. However such control performances are not carried out at all in the case of casino slot machines in the U.S.A. When the symbols to be displayed in the stationary display are determined according to the internal lottery outcomes of the machine, following the passage of a predetermined amount of time, the slot machine automatically stops the rotation of the drums. Accordingly, a player's skill is entirely eliminated. This is carried out also in accordance with the laws governing the U.S.A.

In both the pinball-style slot machine and the casino slot machine, the stop control directly determines not only advantages and disadvantages of the players who bet in the games, but also those of casino houses and pachinko halls. Accordingly, it is natural that the rotation and stopping of the drums must be performed according to the lottery result inside the machine or the stop control. To stop the determined symbols precisely on determined positions, the slot machines are required to have precise drum rotation control. Thus, it is essential that the slot machine has a function for precisely detecting each position of the symbols on each of the drums at any time.

Conventionally, for the detection of the position of each drum, there are techniques with the use of a decoder band, a disk and a gear (Japanese Patent Laid-Open No. 11-333047 Official Gazette, Japanese Patent Laid-Open No. 10-311745 Official Gazette, U.S. Pat. No. 5,058,893 Official Gazette, U.S. Pat. No. 5,839,957 Official Gazette, and U.S. Pat. No. 6,043,483 Official Gazette by reference). For example, when a decoder band and a disk are used for the detection of the symbol position of each drum, it is necessary to detect optical transmission parts and shading parts installed in an alternate pattern with constant intervals around a rotating center axis with a photo sensor.

### SUMMARY OF THE INVENTION

A conventional principle of a position detecting mechanism using a decoder band and a disk is to determine the angle of rotation from an original position by counting and calculating how many times the optical transmission or cutoff from the origin occurred. A certain position on the decoder band or the disk is defined as the origin which corresponds to any one point on a circumference of the drum. Firstly, because it is necessary to determine the original position of the drums when the drums begin to rotate, the drums are required to rotate, at maximum, as much as approximately one revolution towards the arranged position of the detector. In addition to the above, when a counting error or reverse turn by an unexpected situation occurs, the drums must be rotated to the origin. Such errors described above are fatal errors during play in the pinball-style slot machine and the casino's slot machine. In addition, inertia of the drums becomes larger according to a sensor structure, and a large-scaled device is required for position control.

Furthermore, the rotation positions of the drums stopped in the last-played game are stored in the slot machine, and it is recognized by the machine that the rotation of the drums starts from the position when the rotation positions of the drums are detected at the moment of rotation start. Accordingly, a program is required for recognizing through software by the slot machine itself that the drums started to be rotated from that position. However, when there is a difference in the stop positions of the drums by some factors between the last-played game and the game actually to be started, even if a software program is installed, the program cannot compensate such tilts. In addition, the early detection of an error and management were difficult because any anomalies of rotation speed of the drums cannot be detected in such a sensor structure as above.

The present invention was made in view of the problems as mentioned above, it is an object of the present invention to provide a drum device and a slot machine using this drum device, which are capable of detecting symbol position and rotation anomalies of the drums in real time, in which any detection of the original position are not required even at rotation start and rotation anomalies.

According to one embodiment of the present invention, a drum device comprising:

a drum having a cylindrical shape rotatable around a center axis, and displaying plural symbols for displaying at least a part of the plural symbols to the outside on its peripheral surface;

a sensor arranged in close vicinity of the center axis of the drum for detecting a rotating state of the center axis; and

a driving unit for driving the drum,

wherein the drum device detects symbols to be displayed to the outside according to a rotating state of the drum detected by said sensor.

According to the embodiment, the sensor may detect an angle of rotation of the drum.

According to the embodiment, the sensor may detect an angular velocity of the rotation of the drum.

According to the embodiment, the sensor may detect an angular acceleration of the rotation of the drum.

According to the embodiment, the driving unit may be arranged in close vicinity to the center axis, and the sensor is included in the driving unit.

According to the embodiment, the drum device may further have a controlling unit for controlling the rotating state of the drum according to an output outcome from the sensor and a predetermined rotating position.

According to one embodiment of the present invention, a drum device comprising:

plural drums, each of plural drums having a cylindrical shape rotatable around a center axis, and displaying plural symbols for displaying at least a part of the plural symbols to the outside on its peripheral surface;

plural sensors, each of plural which is arranged in close vicinity to the center axis of a corresponding drum of the plural drums for detecting a rotating state of each of center axes; and

plural driving unit for driving corresponding drum,

wherein the drum device detects symbols to be displayed to the outside according to a rotating state of each of the plural drums detected by the plural sensors.

According to the embodiment, each of the plural sensors may detect an angle of rotation of corresponding drum of the plural drums.

According to the embodiment, each of the plural sensors may detect an angular velocity of rotation of the corresponding drum of the plural drums.

According to the embodiment, each of the plural sensors may detect an angular acceleration of rotation of the corresponding drum of the plural drums.

According to the embodiment, each of the plural driving units may be arranged in close vicinity to the center axis of a corresponding drum, and each of the plural sensors may be included in a corresponding driving unit.

According to the embodiment, the drum device may further have a controlling unit for controlling the rotating state of plural drums according to output outcomes from the plural sensors and a predetermined rotating position.

According to one embodiment of the present invention, a slot machine comprising:

A drum device having:
plural drums, each of plural drums having a cylindrical shape rotatable around a center axis, and displaying plural symbols for displaying at least a part of the plural symbols to the outside on its peripheral surface;
plural sensors, each of which is arranged in close vicinity to a center axis of a corresponding drum of the plural drums for detecting a rotating state of each of center axes; and
plural driving units for driving corresponding drum,
wherein the drum device detects symbols to be displayed to the outside according to a rotating state of each of the plural drums detected by the plural sensors; and

a controlling unit for controlling rotations of the plural drums, performance of the plural sensors and performance of the plural driving units, and for judging positions of the plural symbols of each the plural drums according to output outcomes from the plural sensors for detecting the rotating state of each of the center axes of the plural drums.

According to the embodiment, each of the plural sensors may detect an angle of rotation of a corresponding drum of the plural drums.

According to the embodiment, each of the plural sensors may detect an angular velocity of rotation of a corresponding drum of the plural drums.

According to the embodiment, each of the plural sensors may detect an angular acceleration rotation of a corresponding drum of the plural drums.

According to the embodiment, each of the plural driving unit may be arranged in close vicinity to the center axis of a corresponding drum, and each of the plural sensors may be included in a corresponding driving unit.

According to the embodiment, the slot machine controls the rotating state of plural drums according to output outcomes from the plural sensors and a predetermined rotating position.

In the drum device and the slot machine of the present invention, as compared to the drum device and the slot machine using conventional decoder band and the disk which adopt sensors and associated control parts, miniaturization, weight saving, reduction of manufacturing processes, and uprating production efficiency of a detecting mechanism of symbol positions of the drum can be realized since such parts do not have to be equipped.

Particularly, in the slot machine and the drum device of the present invention, because the symbol positions of the drums can be detected in real time by adoption of gyro sensors, the original position detection of the drums which is needed when the symbol position detecting mechanism of the drum with the use of the conventional decoder and the disk is used is no longer needed. Furthermore, the process within the software program described in paragraph [0010] becomes needless.

More particularly, in the slot machine and the drum device of the present invention, as the symbol positions of the drums can be analyzed and detected in real time, when an electric power supply is turned on after having deenergized the slot machine, the original position detection, as an initial starting setup for the drums, does not have to be implemented. Therefore, the tilt of the stopping position of the drum just after supplying the electric power again can be detected instantly. During the process of turning off the electric power supply, the drums are rotated by intervention of feasance or nonfeasance, and when the symbol position differs from a setup program, an unfair winning or non-winning situation is caused. Accordingly, detection of the origin by again rotating the reels just after supplying the electric power again is not required. Therefore, the slot machine and the drum device detect the tilt while maintaining the drum condition, and can notify immediately whether the return condition immediately after the power supply has been turned off is abnormal. Accordingly, needless misunderstanding is not caused to a player.

Furthermore, in the slot machine and the drum device of the present invention, the symbol positions of the drums can be analyzed and detected in real time so that anomalies in the rotation speed of the drums can be detected to prevent a driving mechanism of the drums from damage.

In determining the symbol positions of the drums with the use of the conventional decoder and the disk, for example, detection of “transmission” and “cutoff” are required using a photo sensor, but a phenomenon referred to as chattering can easily occur at the point of change with “transmission” and “cutoff”. Consequently, electric noise occurs in the intermediate state, and extra time is required for elimination of this noise. This noise is an undulated noise caused by the way of switching “ON/OFF” which is generated when the photo sensor detects light. For example, a circuit for properly processing a light source with a momentary status that is half concealed by a shutter, and for converting the processed light source into a rectangular digital waveform is necessary, and additional time for the process is required. On the other hand, in the slot machine and the drum device of the present invention, the symbol positions of the drum are analyzed and detected in real time with the use of the gyro sensor, without using the conventional decoder and a disk, thus, there is no occurrence of the chattering, and no additional time is required for detecting the “transmission” and the “cutoff”.

When the symbol position detecting mechanism of the drums with the use of the conventional decoder band and the disk is used, continuous monitoring of the “transmission” and the “cutoff” of the light is necessary. However, in the slot machine and the drum device of the present invention, the symbol positions of the drums can be analyzed and detected in real time with the use of the gyro sensor without using the conventional decoder and the disk. Therefore, the absolute positions of the drums can be detected and a monitor cycle of symbol position detection of the drums is reduced.

In the case of the method for detecting positions by means of the conventional decoder band, the disk, and a gear, when the number of symbols, i.e., number of stop positions are changed and staggered, every device has to be exchanged since physical modification is necessary. On the other hand, in the slot machine and the drum device of the present invention, the symbol positions of the drums can be detected in real time with the use of the gyro sensor, therefore, the number of symbols (the number of stop positions) can be changed simply by modification of a program alone.

Furthermore, in the slot machine and the drum device of the present invention, for example, when electronic papers are used for displaying the symbols in the drums, and the number and the dimensions of the symbols are adjusted by the program, the symbol positions of the drums can be analyzed and detected with the use of the gyro sensor, thereby the number and the dimensions can be adjusted simply by the program modification alone, and a position detecting device does not need to be exchanged. Therefore, without exchanging operations, modification of a game and rewriting to the drum for exclusive use of a special game are instantly enabled, and an improvement in the degree of freedom of contents can be realized at low-cost.

### BRIEF DESCRIPTION OF THE DRAWINGS

FIG. 1 is a view showing an appearance of one embodiment of a slot machine 1 of the present invention.

FIG. 2 is a schematic configuration diagram showing an internal structure of one embodiment of the slot machine 1 of the present invention.

FIG. 3 is a detailed view of a schematic configuration of a rotational driving mechanism of a drum 5a in a drum device used in one embodiment of the slot machine 1 of the present invention.

FIG. 4 is an outside view of a gyro sensor 26a, used for one embodiment of the slot machine 1 of the present invention.

FIG. 5 is an internal structure view of the gyro sensor 26a, used in one embodiment of the slot machine 1 of the present invention.

FIG. 6 is a conceptual diagram of signal communication between the gyro sensor 26a₁ and an external unit 16 which are installed in the drum 5a in a drum device used in one embodiment of the slot machine 1 of the present invention.

FIG. 7 is a chart showing a schematic configuration of a system for one embodiment of the slot machine 1 of the present invention.

FIG. 8 is a flow chart showing performances of one embodiment of the slot machine 1 of the present invention.

FIG. 9 is a detailed view of a schematic configuration of the rotational driving mechanism of the drum 5a in the drum device used in one embodiment of the slot machine 1 of the present invention.

### DETAILED DESCRIPTION OF THE INVENTION

Preferred embodiments of drum devices and slot machines of the invention are described with reference to the accompanying drawings hereinafter. The drum devices and the slot machines of the present invention are not slot machines which display the symbols on a display in video image, but drum devices and slot machines which comprise a mechanical mechanism respectively. The drum devices and the slot machines of the embodiments of the present invention, which are shown hereinafter, are examples of the drum devices and the slot machines of the present invention. The drum devices and the slot machines of the present invention are not limited to these embodiments.

### Embodiment 1

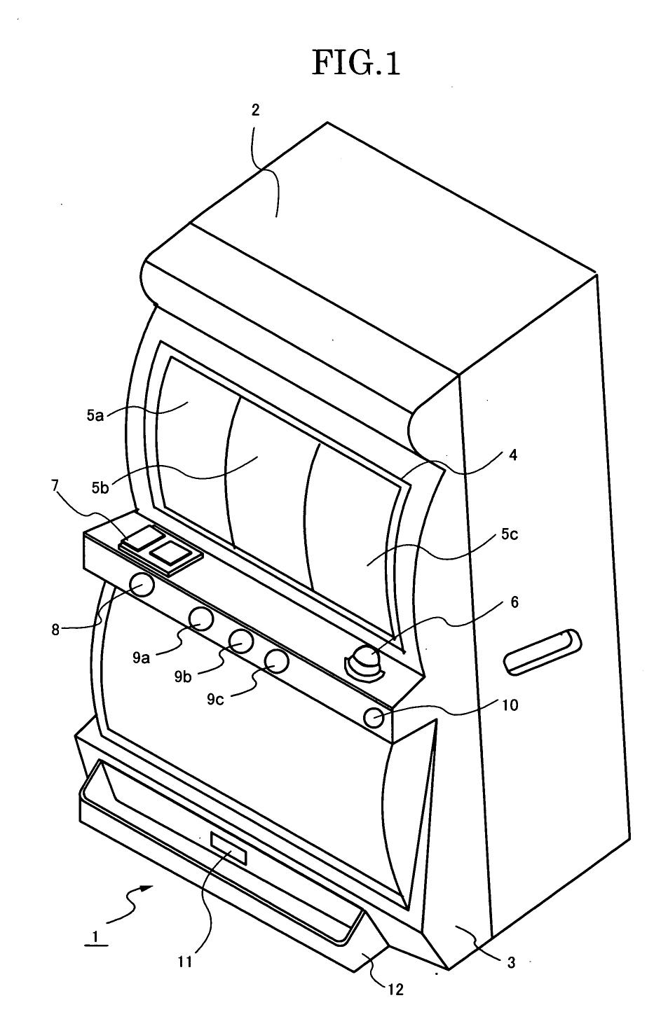

FIG. 1 shows an appearance of a slot machine 1 of the present embodiment of the present invention. In FIG. 1, the slot machine 1 has a housing 2, and a front panel 3 attached to the front of the housing 2 and be opened and closed freely. The front panel 3 has a display window 4. A part of drums 5a, 5b and 5c, which are incorporated in the housing 2, and have printed symbols and numbers on their outer circumference surfaces, can be seen from the display window 4. The front panel 3 also has a coin (medal) slot 6, a BET operation button 7, and a start lever (a start button) 10. Furthermore, the front panel 3 includes stop buttons 9a, 9b and 9c which are a stop operative means of the drums 5a, 5b and 5c. Furthermore, the front panel 3 includes a credit adjustment button 8, a coin payout opening 11, and a coin saucer 12. Particularly, in the case where an inserted coin becomes stuck, a coin return button 6a may be arranged near the coin insertion slot 6 for returning the coin.

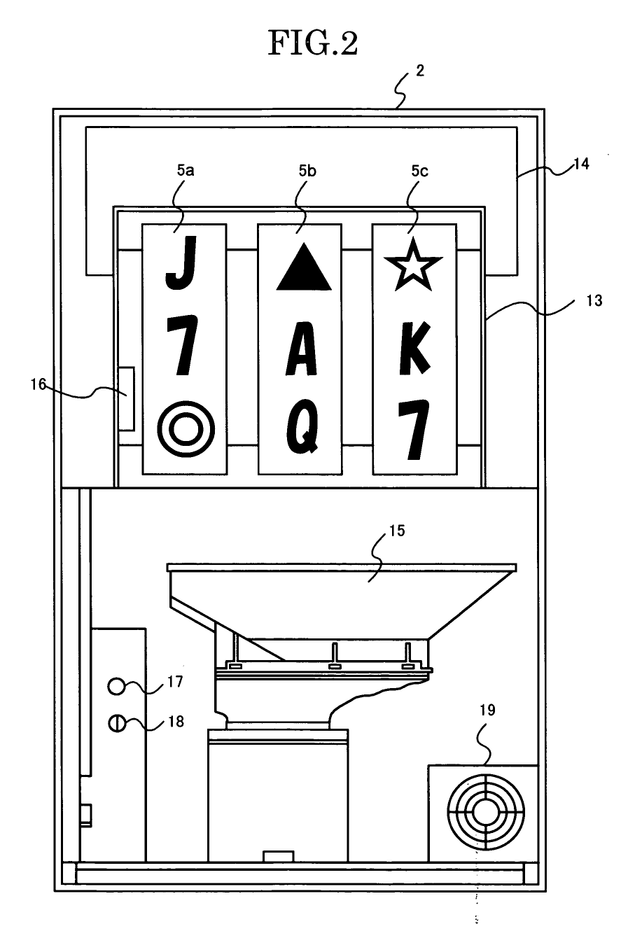

FIG. 2 shows a schematic configuration diagram showing an internal structure of the slot machine 1. In the inside of the housing 2, a drum unit (a drum device) 13 is incorporated. The drum unit 13 has three cylindrical shaped drums 5a, 5b and 5c. The three drums 5a, 5b and 5c are each provided with films on which are printed a plurality of symbols (hereinafter referred to as “symbols”) in a lateral circumferential direction respectively. The housing 2 comprises a main control circuit substrate 14 which is formed of an electric circuit comprised of CPU, ROM and various kinds of electronic parts, a medal payout device 15 which has a medal hopper capable of accommodating multiple coins, an external unit 16, a reset switch 17, a stage setting key switch 18, a speaker 19, and so on.

The reset switch 17 initializes the gyro sensors 26a, 26b, and 26c for detection of the rotation status of the drums 5a, 5b and 5c as described below. The reset switch 17 and the stage setting key switch 18 set up an award lottery table, which is described below, to increase or to reduce the probability of winning a “big bonus” and a “medium bonus”.

The drums 5a, 5b and 5c (hereinafter referred to as a “left drum”, a “middle drum” and a “right drum”) may be rotationally driven respectively by a drum driving motor which constitutes a stepping motor. The drums 5a, 5b and 5c are each provided with films on which are printed a plurality of kinds of symbols with a predetermined order respectively as shown in FIG. 2. In the present embodiment, each of the drums 5a, 5b and 5c is provided with the films which are printed with the plurality of the symbols with the predetermined order so that 3 symbols printed on each film appear within the display window 4 of the front panel 3, but is not limited thereto. For example, not more than 2 or not less than 4 symbols, which are printed on each film of each of the drums 5a, 5b and 5c, may appear within the display window 4 of the front panel 3.

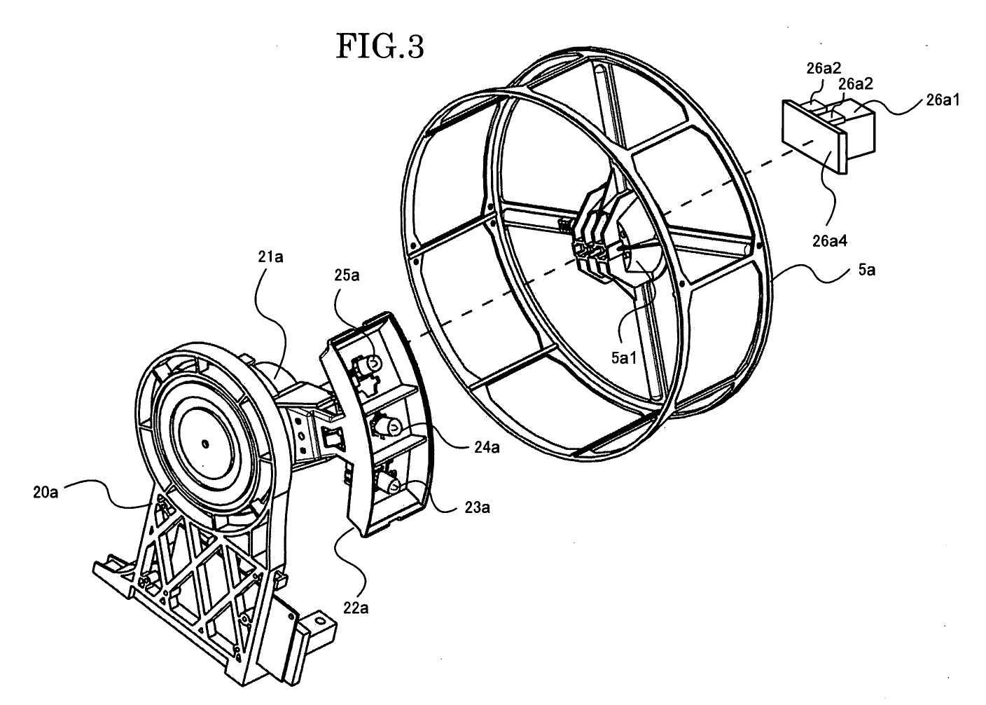

Referring to FIG. 3, a description is made of the rotational driving mechanisms of the drums 5a, 5b and 5c. FIG. 3 shows a detailed view of a schematic configuration of a rotational driving mechanism of the drum 5a. For convenience of explanation, the film printed with the symbols on the drum 5a is not illustrated. FIG. 3 shows the rotational driving mechanism of the drum 5a, however, other drums 5b and 5c have a similar construction as drum 5a. Therefore, descriptions of 5b and 5c are omitted herein.

The rotational driving mechanism of the drum 5a includes a drum drive support 20a and a motor 21a. The motor 21a of the present embodiment uses a stepping motor. A center part 5a1 of the drum 5a is connected to a driving shaft of the motor 21a. Therefore, the drum 5a is held to the driving shaft of the motor 21a. 22a is a luminous unit which provides 3 lamps 23a, 24a and 25a. 26a is a gyro sensor which is installed in the center part 5a1 of the drum 5a. In the present embodiment, the gyro sensor 26a1 is located on a control substrate 26a4 and, the control substrate 26a4 is arranged in the center part 5a1 of the drum 5a. A power supply unit 26a2 supplies electricity to the gyro sensor 26a1. 26a3 is a communication unit connected to the gyro sensor 26a1, and executes control and communication of signals between the gyro sensor 26a1 and an external unit 16 (not illustrated in FIG. 3). In the present embodiment, a piezoelectric oscillatory type gyro sensor, which is an angular velocity sensor, is used for the gyro sensor 26a1. Furthermore, in the present embodiment, a small battery is used for the power supply unit.

The piezoelectric oscillatory type gyro sensor 26a, which is an angular velocity sensor, is a three axial angular velocity sensor using the Coriolis force which is the force generated when an exercising object rotates. The piezoelectric oscillatory type gyro sensor 26a installed in the center part 5a1 of the drum 5a detects a rotating angular velocity and an angle of the rotating drum 5a. The symbol position of the drum 5a can be detected by detecting the angle of the rotating drum 5a. Depending on a controlling method, when a signal from the piezoelectric oscillatory type gyro sensor 26a is read at an appropriate timing, the momentary angle and the rotating angular velocity can be detected. By detecting the angle and the rotating angular velocity (a rotational velocity of the drum), the symbol positions and the rotation of the drums can be controlled and monitored. The information of the angular velocity is effective when the rotation velocity of the drums is controlled voluntarily. Additionally, by omitting a continuous monitoring function, the processing of angle information can be eliminated during drum rotation just after a rotation start-off until a stationary condition.

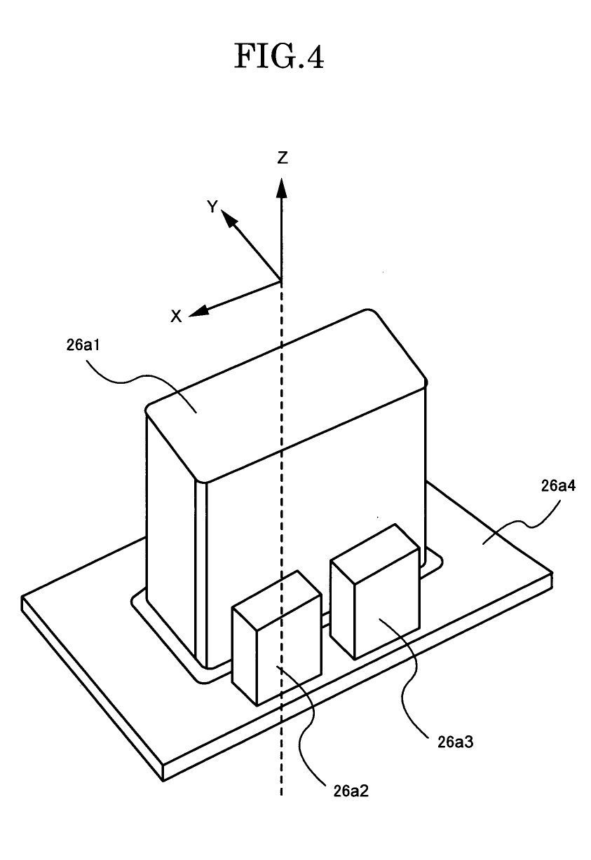

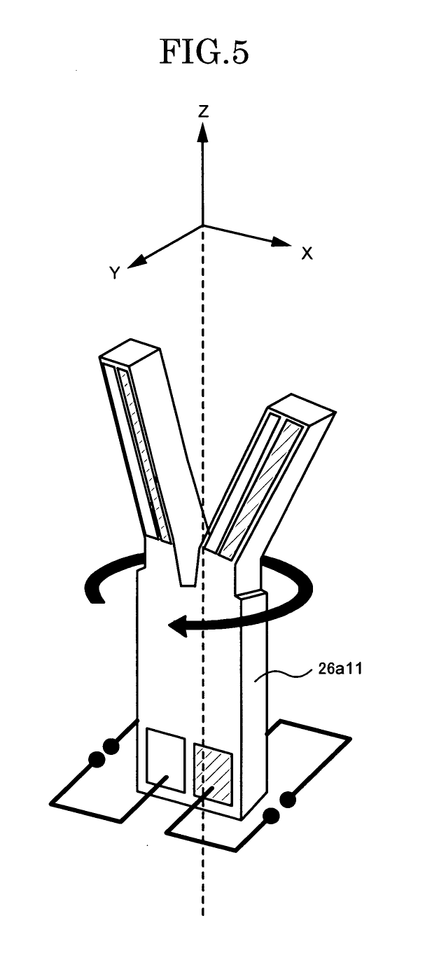

FIG. 4 shows an appearance of the gyro sensor 26a1 used in the present embodiment. FIG. 5 shows an internal structure of the gyro sensor 26a1 used in the present embodiment. The gyro sensor 26a1 used in the present embodiment is protected by a schematic rectangular parallelepiped-shaped cover, LN (lithium niobate: LiNbO₃) is used as a piezoelectric element 26a11. When the piezoelectric element 26a11, which is processed in the shape of a tuning fork in the gyro sensor 26a1, is vibrated in a X-axis direction, the piezoelectric element 26a11 rotates around a Z-axis in concert with the rotation of a center axis of the motor 21a and the drum 5a, therefore, the piezoelectric element 26a11 is vibrated in a Y-direction by the Coriolis force. By detecting the vibration of the Y-direction of the piezoelectric element 26a11 electrically, the angular velocity of the gyro sensor 26a1, i.e., the rotating angular velocity of the rotating drum 5a1, can be detected electrically. In the drum device and the slot machine of the present invention, the gyro sensors are installed on the center part 5a1 of the drum. In other words, the gyro sensors are installed on a center axis vicinity of the drum.

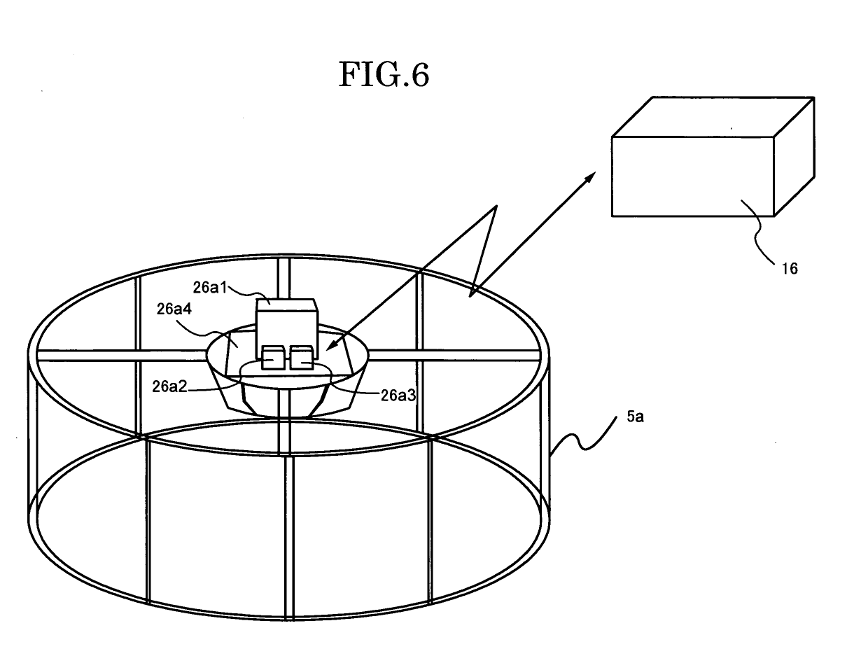

FIG. 6 shows a conceptual diagram of signal communication between the gyro sensor 26a1 and the external unit 16 installed in the drum 5a. In the present embodiment, signal communication is performed by radio between the gyro sensor 26a1 and the external unit 16 through the communication unit 26a3. The communication unit 26a3 receives the angular velocity signal of the gyro sensor 26a1, i.e., a rotating angular velocity signal of the rotating drum 5a1 from the gyro sensor 26a1, and transmits the signal to the external unit 16. The external unit 16 receives the rotating angular velocity signal and outputs the signal to an input port 43 described below. The input port can detect a position of the drum 5a by analyzing the signal from the external unit 16 in a CPU 30 described below.

In the present embodiment, the piezoelectric oscillatory type gyro sensor, which is an angular velocity sensor, is used in the gyro sensor 26a1, but other angular velocity gyro sensors (3-axis, 2-axis) may be used, and the signal based on states of the rotating drums may be obtained with the use of an angular sensor, rotating angular velocity sensor and a rotating angular acceleration sensor, and any gyro sensor which can sense the states of the rotating drums 5a1 and 5a2 and detect the symbol positions of the drum 5a1.

In the present embodiment, a small battery is used for the power supply unit 26a2 for supplying electricity to the gyro sensor 26a1, but a method for supplying electricity to the gyro sensor 26a1 is not limited to this. By using RFID techniques, electricity may be supplied to the gyro sensor 26a1. In the present embodiment, the power supply unit 26a2 is arranged on the control substrate 26a4, but the power supply unit may be arranged on the drum 5a1.

Furthermore, in the present embodiment, radio communication is used for signal communication between the gyro sensor 26a1 and the external unit 16 which are installed on the drum 5a, but cable transmission may be used.

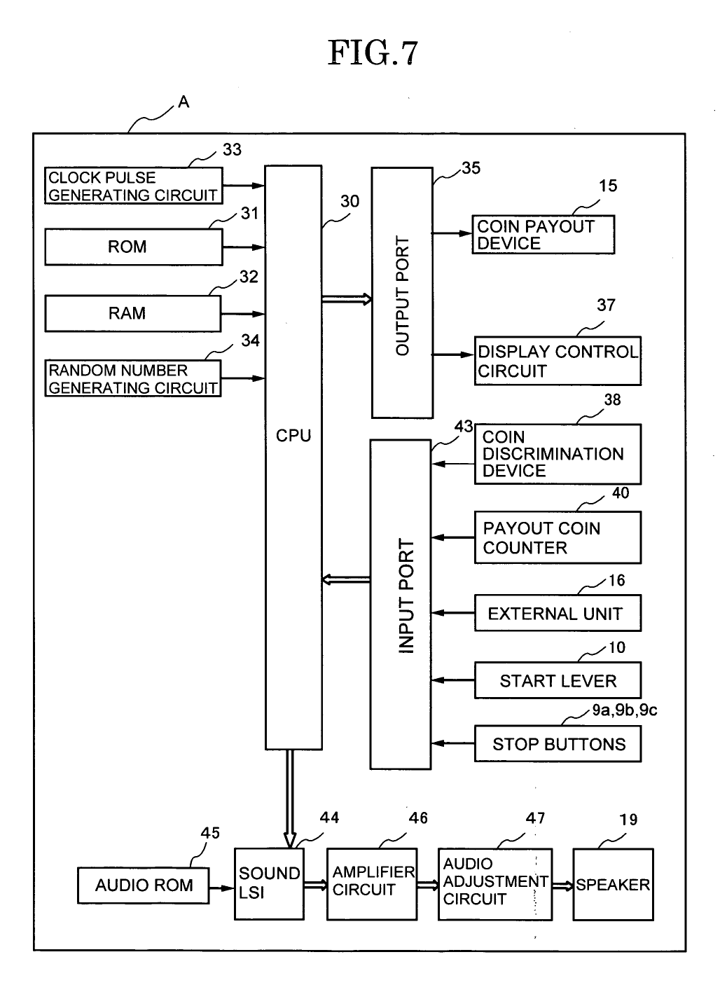

Referring to FIG. 7, a chart showing a schematic construction of a system of the slot machine 1 according to the embodiment of the present invention is shown in FIG. 7. The slot machine 1 of the present invention according to the present embodiment has a main system A as shown FIG. 7. The main system A performs control of performance of the slot machine 1, analysis of signals from the gyro sensor to detect the symbol positions of drums, control of medal payout, and control of the display window.

In the main system A, the CPU 30 comprises a ROM 31 and a RAM 32 and controls the entire performance of the slot machine 1 according to the predetermined program. The ROM 31 comprises a control program for controlling performance of the slot machine 1. Furthermore, the ROM 31 comprises an award lottery table for determining awards in advance (an internal lottery) and for determining an array state of symbols to be displayed within the display window 4 at the stationary display of the drums, a bonus game award lottery table for determining an array state of symbols in a bonus game (the bonus game is a free game which is awarded when a normal game is won), a judgment data table for judging game outcomes in comparison with the determined symbol array, a bonus game judgment data table for judging game outcomes in comparison with the symbol array in the bonus game, a drum symbol position judgment table for analyzing transmitted signals from the gyro sensors 26a, 26b and 26c through a transmitting unit 26a2 and the external unit 16, and for judging the symbol positions of the drums 5a, 5b and 5c, and so on

In the slot machine of the present embodiment, the CPU 30, the ROM 31 and the RAM 32 comprise an arrangement determination unit, a game outcomes judgment unit, a bonus game number determination unit, and a drum position judgment unit. The arrangement determination unit determines the symbol array to be displayed in the display window at the stationary display of the symbols according to the award lottery table. The game outcomes judgment unit judges the game outcomes by comparing the determined symbol array with the judgment data table. The bonus game number determination unit determines the total number of bonus games to be output when the judged game outcome gives an opportunity for the start of the bonus games. The drum symbol position judgment unit analyzes the signals which are transmitted from the gyro sensors 26a, 26b and 26c installed on the drums 5a, 5b and 5c through the transmitting unit 26a2 and the external unit 16 according to the drum position judgment table, determines the symbol positions of the drums 5a, 5b and 5c in real time, and finally determines the stationary positions of the symbols of the drums 5a, 5b and 5c. The gyro sensors 26a, 26b and 26c can detect not only angle information, but also performance of unusual rotation of the drums since the rotating angular velocity information can be output.

The CPU 30 is connected to a clock generating circuit 33 which generates a reference clock pulse and a random numbers generating circuit 34 which generates constant random numbers. The CPU 30 and the random numbers generating circuit 34 comprise the arrangement determination unit and part of the bonus game number determination unit. A control signal transmitted from the CPU 30 is output to a coin payout device 15 for paying coins, and a display control circuit 37 for controlling the display of three lamps 23a, 24a and 25a of the luminous unit 22a through an output port 35.

Output signals from a coin discrimination device 38 for discriminating the propriety of coins, a coin counter 40 for counting the number of coins to be paid out, and a start lever 10 to start a game, and a signal from stop buttons 9a, 9b and 9c for giving an opportunity to stop the rotation of the drums are input to the CPU 30 through the input port 43. A selection unit is formed of the CPU 30, the ROM 31, the RAM 32, the start lever 10, and the stop buttons 9a, 9b and 9c.

Audio data are output to an amplifier circuit 46 from the CPU 30 through a sound LSI 44 for performing speech processing. The sound LSI 44 extracts necessary audio data from an audio ROM 45 and performs the speech processing. The audio data which is processed such as amplification in the amplifier circuit 46 is output to a speaker 19 through an audio adjustment circuit 47 for adjusting the audio data.

In the slot machine 1 of the present embodiment, the normal game is started by a betting operation of a player. The winning line is a line for realizing an award when a combination of the predetermined symbols is arranged thereupon. The winning line may be enabled in multiple setting. The betting operation is performed by inserting a coin into the coin insertion slot 6, or by betting coins pooled (credited) by a “BET” button 7. Alternatively, betting is enabled by using these betting operations together.

The winning line is specified by the betting operation (number of inserted coins) by a player, and then the rotation of the drums 5a, 5b and 5c is started when the start lever 10 (which may be a start button) is operated. When the player operates the stop button 9a, 9b and 9c, or the predetermined time has passed, the drums 9a, 9b and 9c are stopped respectively. When a combination of the predetermined symbols is displayed on any winning lines at the time of this stationary display, the award in response to the combination of the symbols is provided.

The slot machine 1 is provided with the speaker 19 in which a voice guide, music and sound effects are generated.

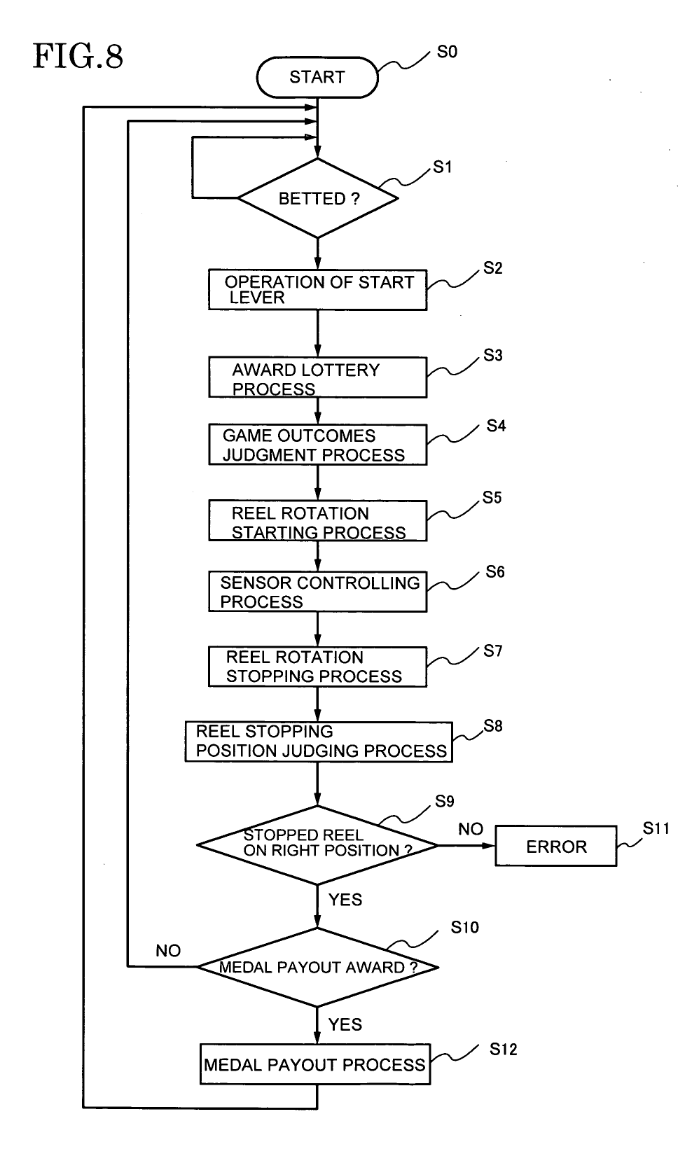

Referring to FIG. 8, a description is made of the operations of the slot machine 1 of the present invention according to the present embodiment constructed as above. FIG. 8 is a flowchart showing performance of the slot machine 1 of the present invention concerning embodiment 1. Firstly, the player inserts coins into the coin insertion slot 6, or coins in credit are cast by a BET button 7 (Step S1), and by operating the start lever 8 by the player, the normal game is started (Step S2).

When the normal game is started, the arrangement determination unit of the main system A determines the symbol array to be displayed in the display window 4 according to the award lottery table at the time of the stationary state of the drums 5a, 5b and 5c (Step S3). The game outcomes judgment unit judges the game outcomes by comparing the determined symbol array with the judgment data table (Step S4). Then the three drums 5a, 5b and 5c rotate upward and downward (Step S5). The communication unit 26a4 receives signals related to the angular velocity from the gyro sensors 26a, 26b and 26c installed in the three drums 5a, 5b and 5c. And the communication unit 26a4 transmits the signals to the external unit 16 (Step S6). The external unit 16 outputs a received signal to the input port 43, and the CPU receives the signal from the input port 43. The CPU analyzes the positions of the drums in real time by comparing the received signal with the drum position judgment table. Next, when the player operates the stop buttons 9a, 9b and 9c, or the predetermined time passes, the process to stop the drums 9a, 9b and 9c is performed by a control means (Step S7). The CPU completes its analysis by comparing the received signal with the drum symbol position judgment table, and judges the stationary position of the symbols of the drums 5a, 5b and 5c (Step S8). At this time, the CPU determines whether the symbols of the drums 5a, 5b and 5c have been stopped exactly on the predetermined positions or not, i.e., whether the drums 5a, 5b and 5c have been stopped so that the symbol array, which is determined by the award lottery table, appears in the display window 4 or not according to the analysis outcomes of the signal (Step S9). When the symbols of the drums 5a, 5b and 5c are not stopped exactly on the determined positions, an error occurs (Step S11), and the game comes to an end. On the other hand, when the symbols of the drums 5a, 5b and 5c are stopped exactly on the determined positions, it is determined whether a symbol array is applicable to the medal payout award, or not (Step 10). When a symbol array is applicable to the medal payout award, a medal payout process is started (Step S12). When the symbol array does not correspond to the medal payout award, the game returns to Step S1.

In determining whether the symbol array corresponds to the medal payout award or not (Step 10), when the symbol array is an array that gives an opportunity to shift to special games, the game shifts to the special games (not shown).

In the slot machine of the present invention, by adoption of the gyro sensor and associated control parts, the detecting mechanism of the symbol positions of the drums can realize miniaturization and weight saving as compared to a position detecting mechanism using the conventional decoder band and disk. The drum symbol position detecting mechanism used for the slot machine of the present invention has a simple structure and is easier to manufacture in comparison with the position detecting mechanism using the conventional decoder band and the disk.

In the slot machine of the present invention, the symbol position of the drums can be analyzed and detected with the gyro sensors in real time, therefore, a drum original position detection, which is required when the drum symbol position detecting mechanism using the conventional decoder band and the disk is used, is no longer required, thereby reducing the time required for a drum rotating process. Furthermore, the program process such as tracing the angle of the drums while maintaining the original position of the drums is no longer required.

Furthermore, in the slot machine of the present invention, the symbol position of the drums is analyzed and detected in real time, therefore, after having cutoff an electric power supply to the slot machine, when the electric power supply is turned on, the original position detection which is used for starting the drums is no longer required. Therefore, the tilt of a stopping position of the drum just after turning on of the electric power supply again can be detected instantly.

Further, in the slot machine of the present invention, the symbol positions of the drums can be analyzed and detected in real time, so that anomalies of rotation speed of the drums can be detected, and a driving mechanism of the drums is prevented from damage.

In determining the symbol positions of the drums with the use of the conventional decoder and the disk, for example, detection of “transmission” and “cutoff” is required with a photo sensor, but phenomenon referred to as chattering can easily occur at the point of change between “transmission” and “cutoff”. Consequently, electric noise occurs in the intermediate state, and extra time is required for elimination of this noise. This noise is a wavy noise caused by the way of switching “ON/OFF” which is generated when a photo sensor detects light, for example, a circuit which processes the noise of a momentary state when a light source is half concealed by a shutter, and converts the noise into a rectangular digital waveform is necessary, and time for the process is required.

On the other hand, in the slot machine of the present invention, the symbol positions of the drums are analyzed and detected in real time with the use of the gyro sensor without the use of the conventional decoder and the disk, therefore, there is no generation of this chattering and there is no generation of time to swing between “transmission” and “cutoff”.

Furthermore, when the symbol position detecting mechanism of the drums with the use of the conventional decoder and the disk is used, continuous monitoring of the “transmission” and “cutoff” of the light is necessary, but in the slot machine of the present invention, the symbol positions of the drums can be analyzed and detected by using the gyro sensor without the conventional decoder band and the disk, and the absolute positions of the drums can be detected, thereby reducing a monitor cycle of symbol position detection of the drums.

[Embodiment 2] In the present embodiment, a description is made of an example which has a gyro sensor included in a motor for driving a drum.

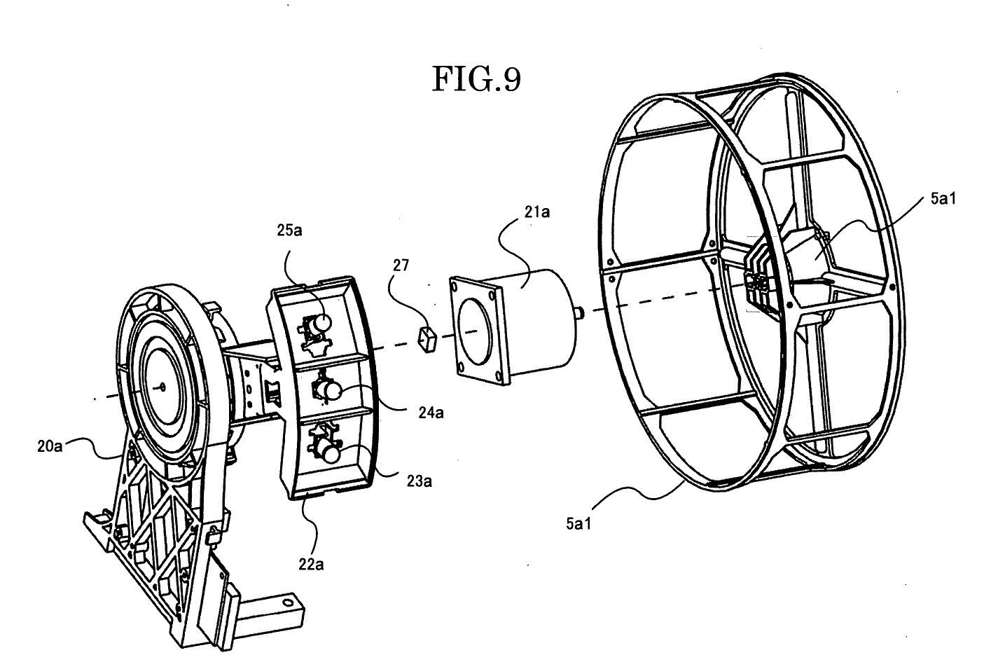

Referring to FIG. 9, a detailed view of a schematic configuration of a rotational driving mechanism of the drum 5a is shown in FIG. 9. For convenience of explanation, the film printed with the symbols on the drum 5a is not illustrated. And FIG. 2 shows a rotational driving mechanism of the drum 5a representatively. The other drums 5b and 5c have a construction similar to drum 5a, so their descriptions are omitted herein. The same construction as the construction explained in the embodiment 1 as above, is designated by the same reference numeral, so that it is not described herein again.

In the present embodiment, a gyro sensor 27a1 is included in a motor 21a. A communication unit (not illustrated) for transmitting a signal from the gyro sensor 27a1 to the external unit 16 by radio is also included in the motor 21a. In the present embodiment, the feed to the gyro sensor 27a1 is performed using an electric supply which is fed to the motor 21a.

In the present embodiment, the piezoelectric oscillatory type gyro sensor which is an angular velocity sensor is used in the gyro sensor 27a1, but other angular velocity gyro sensors (3-axis, 2-axis) may be used, and an angle sensor and an acceleration sensor may be used. Any gyro sensor which can detect the rotating status of the drums 5a1, 5a2 and the symbol position of the drum 5a1, and can be included in the motor 21a, may be used.

Particularly, in the present embodiment, the feed to the gyro sensor 27a1 is performed using an electric supply which is fed to the motor 21a, but a small size battery may be used in the power supply unit for supplying electricity to the gyro sensor 27a1. Furthermore, a method for supplying electricity to the gyro sensor 27a1 is not limited to these, electricity may be supplied to the gyro sensor 27a1 using RFID techniques.

Particularly, in the present embodiment, radio communication is used for signal communication between the gyro sensor 27a1 and the external unit 16 installed on the drum 5a, but cable transmission may be used.

Within the slot machine of the present invention according to the present embodiment, the drum symbol position detecting mechanism can be miniaturized by including the gyro sensor, in addition to the effect described above embodiment 1.

The slot machine of the present invention can be applied to any slot machines using a physical drum, therefore, they it can be applied to the slot machines used in various locations including game centers and casinos.

What are claimed are:

1. A drum device comprising:
a drum having a cylindrical shape rotatable around a center axis, and displaying plural symbols for displaying at least a part of said plural symbols to the outside on its peripheral surface;
a sensor arranged in close vicinity of said center axis of said drum for detecting a rotating state of said center axis; and
a driving unit for driving said drum,
wherein said drum device detects symbols to be displayed to the outside according to a rotating state of said drum detected by said sensor.

2. A drum device according to claim 1, wherein said sensor detects an angle of rotation of said drum.

3. A drum device according to claim 1, wherein said sensor detects an angular velocity of said rotation of said drum.

4. A drum device according to claim 1, wherein said sensor detects an angular acceleration of said rotation of said drum.

5. A drum device according to claim 1, wherein said driving unit is arranged in close vicinity of said center axis, and said sensor is included in said driving-unit.

6. A drum device according to claim 1, wherein said drum device further has a controlling unit for controlling said rotating state of drum according to an output outcome from said sensor and a predetermined rotating position.

7. A drum device comprising:
plural drums, each of plural drums having a cylindrical shape rotatable around a center axis, and displaying plural symbols for displaying at least a part of said plural symbols to the outside on its peripheral surface;
plural sensors, each of plural which is arranged in close vicinity to said center axis of a corresponding drum of said plural drums for detecting a rotating state of each of center axes; and
plural driving unit for driving corresponding drum,
wherein said drum device detects symbols to be displayed to the outside according to a rotating state of each of said plural drums detected by said plural sensors.

8. A drum device according to claim 7, wherein each of said plural sensors detects an angle of rotation of corresponding drum of said plural drums.

9. A drum device according to claim 7, wherein each of said plural sensors detects an angular velocity of rotation of said corresponding drum of said plural drums.

10. A drum device according to claim 7, wherein each of said plural sensors detects an angular acceleration of rotation of said corresponding drum of said plural drums.

11. A drum device according to claim 7, wherein each of said plural driving unit is arranged in close vicinity to said center axis of said corresponding drum, and each of said plural sensors is included in corresponding driving unit.

12. A drum device according to claim 7, wherein said drum device further has a controlling unit for controlling said rotating state of plural drums according to output outcomes from said plural sensors and a predetermined rotating position.

13. A slot machine comprising:
a drum device having:
plural drums, each of plural drums having a cylindrical shape rotatable around a center axis, and displaying plural symbols for displaying at least a part of said plural symbols to the outside on its peripheral surface;
plural sensors, each of which is arranged in close vicinity to a center axis of a corresponding drum of said plural drums for detecting a rotating state of each of center axes; and
plural driving units for driving corresponding drum,
wherein said drum device detects symbols to be displayed to the outside according to a rotating state of each of said plural drums detected by said plural sensors; and
a controlling unit for controlling rotations of said plural drums, performance of said plural sensors and performance of said plural driving units, and for judging positions of said plural symbols of each said plural drums according to output outcomes from said plural sensors for detecting said rotating state of each of said center axes of said plural drums.

14. A slot machine according to claim 13, wherein each of said plural sensors detects an angle of rotation of corresponding drum of said plural drums.

15. A slot machine according to claim 13, wherein each of said plural sensors detects an angular velocity of rotation of corresponding drum of said plural drums.

16. A slot machine according to claim 13, wherein each of said plural sensors detects an angular acceleration rotation of corresponding drum of said plural drums.

17. A slot machine according to claim 13, wherein each of said plural driving unit is arranged in close vicinity to said center axis of said corresponding drum, and each of said plural sensors is included in a corresponding driving unit.

18. A slot machine according to claim 13, wherein said slot machine controls said rotating state of plural drums according to output outcomes from said plural sensors and a predetermined rotating position.
